(19) United States
(12) Patent Application Publication
(10) Pub. No.: US 2021/0122144 A1
(43) Pub. Date: Apr. 29, 2021

(54) LAMINATED GLASS

(71) Applicant: AGC Inc., Tokyo (JP)

(72) Inventor: Shunsuke SADAKANE, Tokyo (JP)

(73) Assignee: AGC Inc., Tokyo (JP)

(21) Appl. No.: 17/143,218

(22) Filed: Jan. 7, 2021

Related U.S. Application Data
(63) Continuation of application No. PCT/JP2019/027935, filed on Jul. 16, 2019.

(30) Foreign Application Priority Data
Jul. 20, 2018 (JP) 2018-137082

(51) Int. Cl. B32B 17/10; B32B 7/12

(52) U.S. Cl. CPC B32B 17/10036; B32B 17/10458; B32B 17/10761; B32B 7/12; B32B 2250/03; B32B 2605/08; B32B 2307/40; B32B 2307/732; B32B 2315/08; B32B 2331/04; B32B 2605/006; B32B 2250/40

(57) ABSTRACT

The present invention relates to a laminated glass having an intermediate film between a glass plate of a vehicle-exterior-side and a glass plate of a vehicle-interior-side, the laminated glass containing: a display area that reflects a projected image from a vehicle cabin and displays information; and a film adhered to one of the glass plates by an adhesive layer is disposed between one of either of the glass plates of the vehicle-exterior-side and the vehicle-interior-side and the intermediate film in at least in a portion of the display area, wherein the thickness of the adhesive layer is 0.2 μm or more and 70 μm or less, and a softening point of the adhesive layer is higher than a glass transition point of the intermediate film.

### CROSS-REFERENCE TO RELATED APPLICATIONS

This U.S. non-provisional application is a continuation application of and claims the benefit of priority under 35 U.S.C. § 365(c) from PCT International Application PCT/JP2019/027935 filed on Jul. 16, 2019, which is designated the U.S., and is based upon and claims the benefit of priority of Japanese Patent Application No. 2018-137082 filed on Jul. 20, 2018, the entire contents of which are incorporated herein by reference.

### TECHNICAL FIELD

The present invention relates to a laminated glass.

### BACKGROUND OF THE INVENTION

Recently, heads-up displays (hereinafter referred to as “HUD”) have been introduced in which images are reflected on the windshield of a vehicle to display predetermined information on a driver's view. One of the problems in a HUD is improving the visibility of a HUD image. For this reason, a technique is known in which a film is fixed within a laminated glass via an adhesive layer, and a projected image from a vehicle cabin is reflected in an area where the film is placed to display information.

Films placed within the laminated glass may vary, but include, for example, films reflecting P polarization. By arranging a film that reflects P polarization in the laminated glass and setting a light source of a HUD to P polarization, the polarization state of an image becomes P polarization. Therefore, a visibility of the HUD image under the polarized sunglasses can be improved.

When a laminated glass is manufactured, for example, an emboss is provided on a surface of an adhesive layer to prevent air bubbles from being left in the laminated glass due to poor degassing.

### RELATED-ART DOCUMENT

### Patent Documents

Patent Document 1: Japanese Unexamined Patent Application Publication (Translation of PCT Application) No. 2006-512622

### SUMMARY OF THE INVENTION

### Problems to be Solved by the Invention

When a film is placed in a laminated glass, the smoothness of the film directly affects the distortion of a HUD image. The present inventors have found that in order to improve film smoothness and reduce the distortion of the HUD image, a thin adhesive layer is required to secure the film.

However, when the adhesive layer is thinned, it is difficult to provide an emboss required for degassing at a sufficient depth on a surface of the adhesive layer, and the degassing ability during a production of a laminated glass may be deteriorated.

An object of the present invention is to provide a laminated glass having an adhesive layer wherein the adhesive layer having a thickness capable of reducing distortion of a HUD image and having excellent degassing ability once the laminated glass has been assembled.

### Means for Solving the Problems

A laminated glass having an intermediate film between a glass plate of a vehicle-exterior-side and a glass plate of a vehicle-interior-side, the laminated glass contains a display area that reflects a projected image from a vehicle cabin and displays information; and a film adhered to one of the glass plates by an adhesive layer is disposed between one of either of the glass plates of the vehicle-exterior-side and the vehicle-interior-side and the intermediate film in at least in a portion of the display area, wherein the thickness of the adhesive layer is 0.2 μm or more and 70 μm or less, and a softening point of the adhesive layer is higher than a glass transition point of the intermediate film.

### Effect of the Invention

According to one embodiment of the invention, a laminated glass having an adhesive layer wherein the adhesive layer having a thickness capable of reducing distortion of a HUD image and having with excellent degassing ability when a laminated glass is produced, can be provided.

### BRIEF DESCRIPTION OF THE DRAWINGS

FIG. 1A is a diagram illustrating a windshield for a vehicle, and is schematically illustrating a windshield viewed from inside to outside of a vehicle cabin (Part 1);

FIG. 1B is a diagram illustrating a windshield for a vehicle, and is schematically illustrating a windshield viewed from inside to outside of a vehicle cabin (Part 1);

FIG. 1C is a diagram illustrating a windshield for a vehicle, and is schematically illustrating a windshield viewed from inside to outside of a vehicle cabin (Part 1);

FIG. 2A is a diagram illustrating a windshield for a vehicle, and is schematically illustrating a windshield viewed from inside to outside of a vehicle cabin (Part 2);

FIG. 2B is a diagram illustrating a windshield for a vehicle, and is schematically illustrating a windshield viewed from inside to outside of a vehicle cabin (Part 2);

FIG. 2C is a diagram illustrating a windshield for a vehicle, and is schematically illustrating a windshield viewed from inside to outside of a vehicle cabin (Part 2);

FIG. 3 is a partial cross-sectional view of a windshield 20 as illustrated in FIG. 1A, and the view is that of a section taken in the x-z direction and viewed from y direction;

FIG. 4 is a diagram illustrating a relationship between time and temperature in a first compression bonding step;

FIG. 5 is a partial cross-sectional view of a windshield 20A similar to the windshield as illustrated in FIG. 1A, and the view is that of a section taken in the x-z direction and viewed from y direction;

FIG. 6 is a partial cross-sectional view of a windshield 20B similar to the windshield as illustrated in FIG. 1A, and the view is that of a section taken in the x-z direction and viewed from y direction;

FIG. 7 is a partial cross-sectional view of a windshield 20C similar to the windshield as illustrated in FIG. 1A, and the view is that of a section taken in the x-z direction and viewed from y direction; and

FIG. 8 is a diagram explaining Examples and Comparative Examples.

### DETAILED DESCRIPTION OF THE INVENTION

Hereinafter, an embodiment for carrying out the invention with reference to the drawings will be described. In each drawing, the same components are indicated by the same reference numerals and overlapping descriptions may be omitted. In each drawing, the size and shape may be partially exaggerated to facilitate understanding of the subject matter of the invention.

A windshield for a vehicle will be described by way of example, but the windshield according to the embodiment is not limited thereto. A laminated glass according to the embodiment can also be used in applications other than as a windshield for a vehicle. Also, vehicle typically refers to an automobile but also refers to a mobile body which has glass, including trains, ships, aircraft, and the like.

A Planar view refers to viewing a predetermined area of a windshield from a normal direction of a predetermined area, and a planar shape refers to a shape viewing a predetermined area of a windshield from a normal direction of a predetermined area. In the specification, the top and bottom refer to the z-axis direction of the drawings, and the left and right refer to the y-axis direction of the drawings.

### First Embodiment

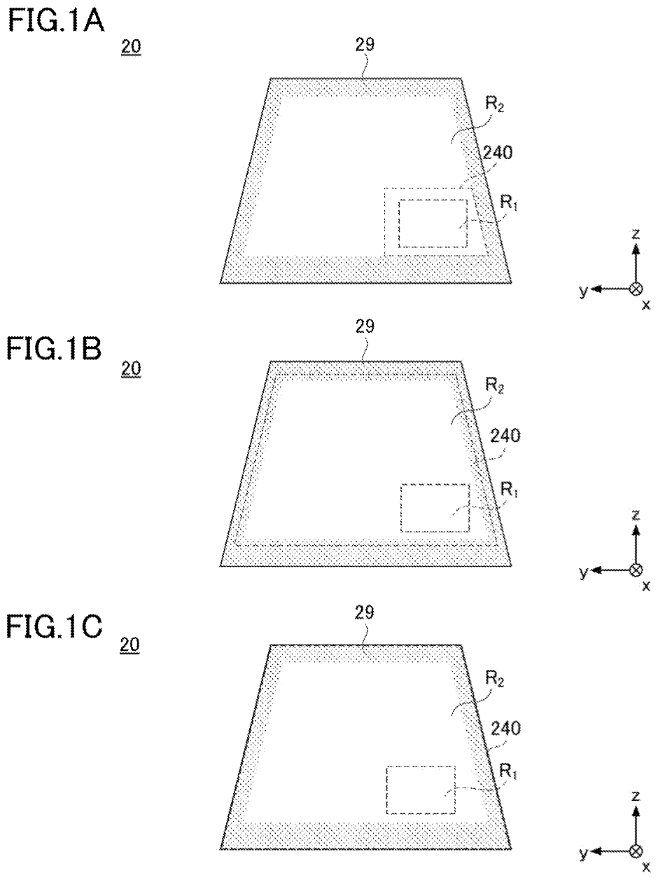

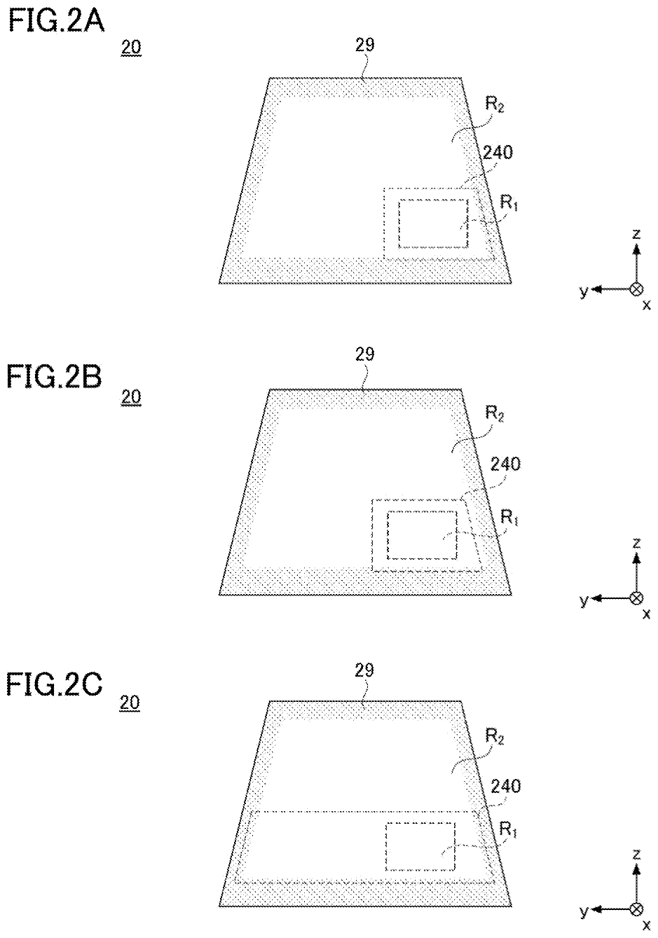

FIGS. 1A to 1C and 2A to 2C are diagrams illustrating windshields for a vehicle and schematically illustrate how the windshields are viewed from inside to outside of the vehicle cabin.

As illustrated in FIG. 1A, a windshield 20 includes a HUD display area R₁ used in a HUD and a HUD non-display area R₂ (transparent area) not used in the HUD. The HUD display area R₁ is a display area that reflects a projected image from the vehicle cabin to display information. The HUD display area R₁ is an area range in which the windshield 20 is irradiated with light from mirrors constituting the HUD when the mirrors constituting the HUD arranged in the vehicle are rotated and viewed from the V1 point of JIS R3212. Also, in the specification, the transparent area refers to a test region C defined in JIS R3211.

Preferably, a black ceramic layer 29 is preferably arranged along the periphery of the windshield 20. The black ceramic layer 29 can be formed by applying a black ceramic printing ink to a glass surface and printing the ink on the glass surface. The presence of the black opaque black ceramic layer 29 along the periphery of the windshield 20 prevents degradation due to ultraviolet light of resins, such as urethane, that hold the periphery of the windshield 20 to the vehicle body. The black ceramic layer 29 is preferably present on a surface of glass plate at vehicle-interior-side, on a surface of glass plate at vehicle-interior-side, or both.

The HUD display area R₁ is located, for example, lower side of the windshield 20, and the HUD non-display area R₂ is located around the HUD display area R₁ of the windshield 20. In the example of FIG. 1A, a film 240 is provided in the HUD display area R₁ and its neighboring area. The film 240 does not have portions overlapping the black ceramic layer 29.

The film 240 may, for example, include the entire HUD display area R₁ and the entire HUD non-display area R₂, as illustrated in FIG. 1B, in which the outer periphery of the film may overlap with the inner periphery of the black ceramic layer 29. The film 240 may also include the entire HUD display area R₁ and the entire HUD non-display area R₂, for example, as illustrated in FIG. 1C, in which the outer periphery of the film may overlap with the entire black ceramic layer 29.

The film 240 may include, for example, a HUD display area R₁ and its neighboring area as illustrated in FIG. 2A, in which the lower edge and one edge side of the film may overlap with the inner periphery of the black ceramic layer 29. The film 240 may also include a HUD display area R₁ and its neighboring area, for example, as illustrated in FIG. 2B, in which the lower edge of the film may overlap with the inner periphery of the black ceramic layer 29. The film 240 may also include a HUD display area R₁ and its neighboring area, for example, as illustrated in FIG. 2C, in which the lower edge and both edge sides of the film may overlap the inner periphery of the black ceramic layer 29.

The HUD display area is not limited to one area. For example, the HUD display area may be arranged in multiple areas in the z-direction or may be arranged in multiple areas in the y-direction. When the HUD display areas are separately disposed at a plurality of areas, at least a portion of the HUD display area may be provided with a film 240, and preferably the entire HUD display area is provided with a film 240.

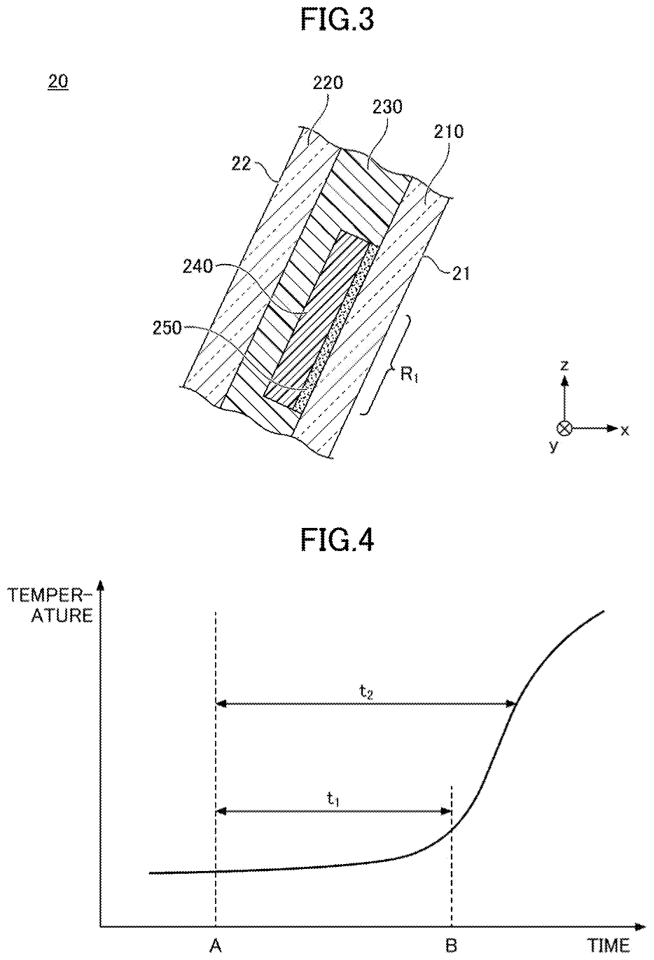

FIG. 3 is a partial cross-sectional view of the windshield 20 illustrated in FIG. 1A cut in the x-z direction and viewed from the y direction. As illustrated in FIG. 3, the windshield 20 is a laminated glass having an intermediate film 230, a film 240, and an adhesive layer 250, these are disposed between a glass plate 210 at a vehicle-interior-side and a glass plate 220 at a vehicle-exterior-side.

Here, a partial cross-sectional view of the windshield 20 illustrated in FIG. 1A will be described. However, FIGS. 1B, 1C, and 2A to 2C differ only in the size of the film 240 and its overlap with the black ceramic layer 29, and the basic cross-sectional shape as the windshield 20 is almost identical.

In the HUD display area R₁ of the windshield 20, the film 240 and the adhesive layer 250 are disposed between the glass plate 210 and the intermediate film 230. A vehicle-interior-side surface of the film 240 is adhered to a vehicle-exterior-side surface of the glass plate 210 with the adhesive layer 250. A vehicle-exterior-side surface of the film 240 is adhered to a vehicle-interior-side surface of the glass plate 220 with the intermediate film 230.

The film 240 is a visible light control film that reflects a projected image from a vehicle cabin, and is not particularly limited if the visible light control film has a predetermined function such as improving visibility under predetermined conditions. The film 240 includes, for example, a P-polarized reflective film, a hologram film, a scattered transparent screen, an enhanced reflective film for HUD, and the like. The thickness of the film 240 can be, for example, 25 μm or more and 200 μm or less. The thickness of the film 240 is preferably 150 μm or less and more preferably 100 μm or less. When the thickness of the film 240 is 100 μm or less, the degassing property when manufacturing laminated glass is improved. The film 240 is transparent to visible light.

The windshield 20 in which the film 240 is disposed has a visible light reflectance of 9% or more or a diffuse reflectance of 9% or more. The visible light reflectance of the windshield 20 in the area where the film 240 is disposed may tend to be high such as 10%, 11%, 11.5%, and 12%. Also, the diffuse reflectance may also tend to be high such as 10%, 11%, 11.5%, and 12%. The higher the visible light reflectance or diffuse reflectance of the windshield 20 in which the film 240 is enclosed, the more pronounced the irregularities of the film 240 are likely formed. Therefore, it is important to improve the smoothness of the film 240.

Here, the visible light reflectance is in accordance with the measurement and calculation method described in JIS R3106. The diffuse reflectance is a method for measuring the spectral reflectance described in JIS R3106, in which diffuse reflected light including reflection other than normal reflection is measured by the integration sphere, and is derived by the same method as the visible reflectance. Here, as used herein, the visible and diffuse reflectance of the windshield 20 is measured in a transparent portion where the black ceramic layer 29 is not disposed.

When the film 240 is a P-polarized reflective film, the reflectance of the P-polarization at a Brewster angle is preferably 5% or more when the film is enclosed in the windshield 20. If the reflectance of the P-polarization is 5% or more, a HUD image is visible. The reflectance of the P-polarization is calculated by measuring the spectral reflectance described in JIS R3106 based on the P-polarization at a predetermined angle of incidence at the visible wavelength and using the method for calculating the visible reflectance described in JIS R3106.

The material of the adhesive layer 250 has a predetermined softening point which will be described in detail below, and is not particularly limited if the material of the adhesive layer has the function of bonding the film 240. Examples of the material of the adhesive layer include acrylic, acrylate, urethane, urethane acrylate, epoxy, epoxy acrylate, polyolefin, modified olefin, polypropylene, ethylene vinyl alcohol, vinyl chloride, chloroprene rubber, cyanoacrylate, polyamide, polyimide, polystyrene, and polyvinyl butyral. The material of the adhesive layer 250 is transparent to visible light. The material of the adhesive layer 250 is preferably lacks an adhesiveness at ambient temperature prior to an assembling a laminated glass.

The thickness of the adhesive layer 250 is 0.2 μm or more and 70 μm or less. When the thickness of the adhesive layer 250 is 0.2 μm or more, the adhesive layer 250 mitigates a thermal shrinkage ratio difference between the glass plate 210 and the film 240 during compression bonding when manufacturing a laminated glass. Therefore, the smoothness of a vehicle-interior-side surface and exterior-side surface of the film 240 can be maintained, and the distortion of a HUD image can be reduced. Further, when the thickness of the adhesive layer 250 is 0.2 μm or more, the edge degradation of the adhesive layer 250 can be prevented when the laminated glass is repeatedly exposed to a high-temperature and high-humidity environment.

Further, when the thickness of the adhesive layer 250 is 70 μm or less, a vehicle-interior-side surface and exterior-side surface of the film 240 follow a smooth surface of a vehicle-exterior-side surface of the glass plate 210. Therefore, the smoothness of a vehicle-interior-side surface and exterior-side surface of the film 240 can be maintained, and a distortion of a HUD image can be reduced. In particular, in a configuration in which an image enlarged by a concave mirror or the like is further enlarged and reflected by a laminated glass of a curved surface, a slight waviness of the vehicle-interior-side surface and exterior-side surface of the film 240 causes a large distortion in a HUD image. Therefore, it is extremely important to improve the smoothness of a vehicle-interior-side surface and exterior-side surface of the film 240. When the thickness of the adhesive layer 250 is 70 μm or less, the distortion of a HUD image can be reduced even when an image enlarged by the concave mirror or the like is further enlarged and reflected by the laminated glass of the curved surface.

The thickness of the adhesive layer 250 is more preferably 60 μm or less, even more preferably 50 μm or less, even more preferably 30 μm or less, even more preferably 20 μm or less, even more preferably 10 μm or less, even more preferably 5 μm or less, even more preferably 3 μm or less, particularly preferably 2 μm or less, and most preferably 1 μm or less.

In the above range, the vehicle-interior-side surface and exterior-side surface of the film 240 can more easily conform to the smooth surface of the vehicle-exterior-side surface of the glass plate 210. Therefore, the smoothness of vehicle-interior-side surface and exterior-side surface of the film 240 are improved, a distortion of a HUD image can be further reduced. The thickness of the adhesive layer 250 is further preferably 5 μm or less and particularly preferably 3 μm or less from the following standpoint. When the thickness of the adhesive layer 250 is 5 μm or less and further 3 μm or less, a distortion of a HUD image caused by the waviness of the film is not noticeable even when a field of view (FOV) of the HUD image increases.

In addition, when the thickness of the adhesive layer 250 is t₁ [mm] and the Young's modulus is E₁ [N/mm²], a relationship of the t₁ and the E₁ preferably satisfies the following: E₁t₁³≥5×10⁻¹².

Here, the Young's modulus E₁ in the specification is obtained by dividing the “maximum load to cut” in Section 8 of JIS 20237 “Method of testing adhesive tape and adhesive sheet” by the “elongation” at that time and then dividing by the “initial cross-sectional area” of the test piece. In the above range, even though the thickness t₁ of the adhesive layer 250 is small, a rigidity of the adhesive layer 250 can be ensured when the Young's modulus E₁ is large. When the thickness t₁ of the adhesive layer 250 is large, the rigidity necessary to reduce the distortion of the HUD image of the adhesive layer 250 can be ensured, even if the Young's modulus E₁ is small.

Note that, the value of 5×10⁻¹² is experimentally determined based on the rigidity of the adhesive layer 250 that does not cause distortion of a HUD image. The relationship of t₁ and E₁ preferably satisfies E₁t₁³≥5×10⁻¹¹, and more preferably E₁t₁³≥5×10⁻¹⁰, and particularly preferably E₁t₁³≥5×10⁻⁹. Further, E₁ is preferably 5 kPa or more, more preferably 10 kPa or more, and further preferably 20 kPa or more.

Also, when the FOV of the HUD image is 4 deg×1 deg or more, the windshield 20 projects a larger HUD image than conventional windshields, so that the waviness in a film 240 is easily generated. Therefore, it is highly important to control the thickness of the adhesive layer 250 to reduce a distortion of a HUD image. As the FOV of the HUD image becomes 5 deg×1.5 deg or more, 6 deg×2 deg or more, and 7 deg×3 deg or more, the windshield 20 projects a larger HUD image than conventional windshields, a distortion of a HUD image due to the waviness of the film 240 more noticeable. Therefore, it is highly important to control the thickness of the adhesive layer 250 to reduce a distortion of a HUD image.

Also, in the adhesive layer 250, the difference of the principal refractive index in light with the wavelength of 550 nm in the in-plane direction (in the direction perpendicular to the thickness direction) is preferably within 0.1. When the adhesive layer 250 located vehicle-interior-side than the film 240 meets the above conditions, the film 240 can reduce the effect on the polarization state of the P-polarization reaching the film 240 in the case of a P-polarized film.

The area of the adhesive layer 250 may be 400 cm² or more, 1,000 cm² or more, 1,500 cm² or more, 5,000 cm² or more, and 10,000 cm² or more. The larger the area of the adhesive layer 250, the more likely the degassing property will deteriorate. Therefore, the use of the adhesive layer of the present invention is highly significant.

In the windshield 20, an inner surface 21, which is one side of the glass plate 210 disposed on the vehicle-interior-side, and an outer surface 22, which is one side of the glass plate 220 disposed on the vehicle-exterior-side, may be flat or curved surfaces. Note that, one side (inner surface 21) of the glass plate 210 and the other side of the glass plate 210, which is the opposite side, are smooth surfaces. Also, one side (outer surface 22) of the glass plate 220 and the other side of the glass plate 220, which is opposite, are smooth surfaces.

In the HUD display area, a curvature of the windshield 20 (laminated glass) in the horizontal direction in the vehicle width direction preferably has a radius in the range of 1,000 mm to 10,000 mm. Also, in the HUD display area, a curvature of the windshield 20 in a vertical direction, in which the vertical direction is along the windshield 20, perpendicular to the horizontal direction preferably has a radius in the range of 4,000 mm to 20,000 mm, and more preferably in the range of 6,000 mm to 20,000 mm. When the curvatures in the vertical and horizontal directions are within the above range, a distortion of a HUD image projected onto the film 240 can be reduced. The smaller the radius, the easier to wrinkle the film. In the drawings, the horizontal direction is along the curved surface of the windshield in the z-axis direction and the vertical direction is along the curved surface of the windshield in the y-axis direction.

For example, soda lime glass, aluminosilicate, borosilicate glass, alkali-free glass, organic glass, and the like may be used for the glass plates 210 and 220. The glass plates 210 and 220 can be made, for example, by the float method.

The thickness of the thinnest portion of the glass plate 220 located on the exterior side of the windshield 20 is preferably 1.8 mm or more and 3 mm or less. When the thickness of the thinnest portion of the glass plate 220 is 1.8 mm or more, the strength of a resistance to windshield chipping and cracking or the like is sufficient. When the thickness of the thinnest portion of the glass plate 220 is 3 mm or less, the mass of the laminated glass is not too large, and it is preferable in terms of the fuel economy of the vehicle. The thickness of the thinnest portion of the glass plate 220 is more preferably 1.8 mm or more and 2.8 mm or less, and further preferably 1.8 mm or more and 2.6 mm or less.

The thickness of the glass plate 210 located interior side of the windshield 20 is 0.3 mm or more and 2.3 mm or less. When the thickness of the glass plate 210 is 0.3 mm or more, handling property is favorable. When the thickness of the glass plate 20 is 2.3 mm or less, the mass of the windshield 20 does not become too large.

When the thickness of the glass plate 210 is 0.3 mm or more and 2.3 mm or less, a glass quality (e.g., residual stress) can be maintained. It is particularly beneficial for maintaining a glass quality (e.g., residual stress) fora deeply curved glass to adjust a thickness of a glass plate to 0.2 mm or more and 2.3 mm or less. The thickness of the glass plate 210 is preferably 0.5 mm or more and 2.1 mm or less, and further more preferably 0.7 mm or more and 1.9 mm or less.

However, the thicknesses of the glass plates 210 and 220 are not always constant and may vary from place to place as needed. For example, one or both of the glass plates 210 and 220 may have a wedge-like area in cross-sectional view in which the thickness of the upper edge is thicker than that of the lower edge in the vertical direction when the windshield 20 is mounted to a vehicle.

When the windshield 20 is curved, then the glass plates 210 and 220 are subjected to a bend-molding by a float method or the like prior to adhesion of the intermediate film 230. The bend-molding is accomplished by softening glass by heating. The glass is heated approximately 550° C. to 700° C. during bend-molding of the glass.

Thermoplastic resins are frequently used as the intermediate film 230 for adhering the glass plate 210 to the glass plate 220. For example, thermoplastic resins which have been used for such applications as plasticized polyvinyl acetal-based resins, plasticized polyvinyl chloride-based resins, saturated polyester-based resins, plasticized saturated polyester-based resins, polyurethane-based resins, plasticized polyurethane-based resins, ethylene-vinyl acetate copolymer-based resins, ethylene-ethyl acrylate copolymer-based resins, and the like. Resin compositions containing modified block copolymer hydrides as described in Japanese Pat. No. 6065221 may also be suitably employed.

Among these, plasticized polyvinyl acetal-based resin is preferably used because it has excellent balance of various performance properties such as transparency, weather resistance, strength, adhesion, penetration resistance, shock energy absorption, moisture resistance, thermal insulation, and sound insulation. These thermoplastics may be used alone or in combinations of two or more types. “Plasticization” in the above-described plasticized polyvinyl acetal-based resin refers to plasticization by the addition of a plasticizer. The same applies to other plasticized resins.

The above-described polyvinyl acetal-based resin includes a polyvinyl formal resin obtained by reacting a polyvinyl alcohol (hereinafter, sometimes referred to as “PVA”) with formaldehyde, a narrowly defined polyvinyl acetal resin obtained by reacting a PVA with acetaldehyde, and a polyvinyl butyral resin obtained by reacting a PVA with n-butyraldehyde (hereinafter, sometimes referred to as “PVB”). In particular, PVB is considered to be suitable because it has excellent balance of various performance characteristics such as transparency, weather resistance, strength, adhesion, penetration-resistance, impact energy absorption, moisture resistance, heat insulation, and sound insulation. These polyvinyl acetal-based resins may be used alone or in combination of two or more kinds. However, the material forming the intermediate film 230 is not limited to thermoplastic resins.

The thickness of the intermediate film 230 is preferably 0.5 mm or more in the thinnest portion. When the thickness of the intermediate film 230 is 0.5 mm or more, the necessary penetration resistance as a windshield is sufficient. In addition, the thickness of the intermediate film 230 is preferably 3 mm or less at the thickest portion. When the maximum thickness of the intermediate film 230 is 3 mm or less, the mass of the laminated glass does not increase too much. The maximum thickness of the intermediate film 230 is more preferably 2.8 mm or less, and further preferably 2.6 mm or less.

However, the thickness of the intermediate film 230 is not always constant, and may vary from place to place as needed. For example, the intermediate film 230 may have a wedge-like area in cross-sectional view in which the thickness of the upper edge is thicker than that of the lower edge in the vertical direction when the windshield 20 is mounted to a vehicle.

The intermediate film 230 may have three or more layers. For example, the intermediate film is formed from three layers, and the hardness of the middle layer is lowered below the hardness of both layers by adjusting the amount of the plasticizer or the like, thereby improving the sound insulation performance of the laminated glass. In this case, the hardness of both layers may be the same or different.

In order to prepare the intermediate film 230, for example, the above-described resin material of the respective intermediate films is appropriately selected and extruded and molded in a heated melt state using an extruder. The extrusion conditions such as extrusion speed of the extruder is set to be uniform. Thereafter, the intermediate film 230 is completed by extending the extruded resin film, for example, as needed, to provide curvature to the upper and lower sides of the intermediate film 230 in accordance with the design of the windshield 20.

The laminated glass is prepared by sandwiching the intermediate film 230, the film 240, and the adhesive layer 250 (the adhesive layer 250 is previously provided on one side of the film 240) between the glass plate 210 and the glass plate 220. Thereafter, for example, the laminated body is placed in a rubber bag, the rubber bag is connected to the exhaust system, and the laminated body is compressed in the rubber bug by performing vacuum suction (degassing) at a temperature of about 70 to 110° C. so that the degree of pressure reduction is −100 to −65 kPa (the first compression bonding step).

Further, by performing a compression bonding step (the second compression bonding step) in which the previously obtained laminated body is heat-pressurized under a condition of, for example, a pressure of 0.6 to 1.3 MPa and at a temperature of 100 to 150° C., a laminated glass having superior durability can be obtained. However, in some cases, the second compression bonding step may be omitted due to the simplification of the steps and the properties of the material enclosed in the laminated glass.

To the extent that the effect of the present application is not impaired, in addition to the intermediate film 230 and the film 240, films or devices having functions such as infrared reflection, luminescence, dimming, visible light reflectance, scattering, decoration, absorption, or the like may be provided between the glass plate 210 and the glass plate 220.

In order to improve the degassing of the intermediate film 230 in the first compression bonding step, that is, the degassing of residual air between the glass plate 210, the glass plate 220, and the intermediate film 230, an embossing may be performed on both surfaces of the intermediate film 230 when manufacturing the laminated glass. As described above, the thickness of the intermediate film 230 is about 0.5 mm or more and 3 mm or less. In contrast, an emboss has a depth of about 70 μm, thereby improving the degassing of the intermediate film 230 in the first compression bonding step.

In contrast, the thickness of the adhesive layer 250 is 70 μm or less, it is difficult to provide a sufficient depth of embossing on the surface of the adhesive layer 250 to improve degassing. Therefore, according to the present embodiment, the time and temperature in the first compression bonding step are correlated as illustrated in FIG. 4, so that the degassing of the adhesive layer 250 is improved. That is, the degassing of residual air between the glass plate 210 and the adhesive 250 is improved even when the embossing is not provided on the surface of the adhesive layer 250.

In FIG. 4, when degassing starts at time A and time B is reached after time t₁ has elapsed, the glass plates 210 and 220 and the intermediate film 230 begin to adhere tightly in the periphery of the glass plates 210 and 220 (hereinafter, also called “edge sealing starts”). Time t₁ is the time until the temperature reaches the glass transition point (Tg) of the intermediate film 230, which is the degassing time of the intermediate film 230.

For the adhesive layer 250, which is difficult to emboss, sufficient degassing must be performed during the degassing time of the intermediate film 230. Therefore, in the windshield 20, the softening point of the adhesive layer 250 is higher than the glass transition point of the intermediate film 230 in order to improve the degassing of the adhesive layer 250. This allows sufficient degassing time to be secured in the adhesive layer 250 prior to the generation of the edge sealing of the intermediate film 230 and the adhesive layer 250 to complete degassing of the adhesive layer 250. When the intermediate film 230 has a plurality of layers, the softening point of the adhesive layer 250 is higher than the glass transition point of all the layers of the intermediate film 230.

The softening point of the adhesive layer 250 is preferably 50° C. or higher, more preferably 60° C. or higher, even more preferably 70° C. or higher, even more preferably 80° C. or higher, particularly preferably 90° C. or higher, and most preferably 100° C. or higher. The higher the softening point of the adhesive layer 250, the less adhesion of the adhesive layer 250 to the glass plate 210 is sufficiently progressed until the degassing time t₂ when the intermediate film 230 is completely in contact with the glass plates 210 and 220 when manufacturing the laminated glass. Therefore, the degassing of the adhesive layer 250 can be completed in plenty of time. In addition, the higher the softening point of the adhesive layer 250, the shorter the time in which the adhesive layer 250 is exposed to a state greater than or equal to the softening point, and thus the smoothness of the film is maintained.

In addition, the difference between the softening point of the adhesive layer 250 and the glass transition point of the intermediate film 230 is preferably large. Specifically, the difference between the softening point of the adhesive layer 250 and the glass transition point of the intermediate film 230 is preferably 10° C. or higher, more preferably 20° C. or higher, and even more preferably 30° C. or higher. The larger the difference between the softening point of the adhesive layer 250 and the glass transition point of the intermediate film 230, the less the adhesion of the adhesive layer 250 to the glass plate 210 is sufficiently progressed until the degassing time t₂ when the adhesive layer 250 is completely in contact with the glass plates 210 and 220 when manufacturing the laminated glass. Therefore, the degassing of the adhesive layer 250 can be completed with a margin.

In addition, the glass transition point of the intermediate film 230 is preferably 40° C. or lower. When the glass transition point of the intermediate film 230 is 40° C. or lower, it is easy to increase the difference between the softening point of the adhesive layer 250 and the glass transition point of the intermediate film 230. Materials having a glass transition point of 40° C. or lower include, for example, PVB.

The softening point of the adhesive layer 250 is measured by the measurement method defined in JIS 1(6863:1994. The glass transition point of the intermediate film 230 is measured by the measurement method defined in ISO 11357-2.

In addition, the storage elasticity in the dynamic viscoelasticity measurement at the measurement frequency of 10 Hz of the adhesive layer 250 is preferably 1.0×10⁷ Pa or more in the temperature range of 20° C. or lower and 1.0×10⁷ Pa or less in the temperature range of 110° C.

The storage elasticity is more preferably 1.0×10⁷ Pa or more in the temperature range of 20 to 30° C., even more preferably 1.0×10⁷ Pa or more in the temperature range of 20 to 40° C., even more preferably 1.0×10⁷ Pa or more in the temperature range of 20 to 50° C., even more preferably 1.0×10⁷ Pa or more in the temperature range of 20 to 60° C., even more preferably 1.0×10⁷ Pa or more in the temperature range of 20 to 70° C., even more preferably 1.0×10⁷ Pa or more in the temperature range of 20 to 80° C., particularly preferably 1.0×10⁷ Pa or more in the temperature range of 20 to 90° C., and most preferably 1.0×10⁷ Pa or more in the temperature range of 20 to 100° C.

Thus, in the windshield 20 which is a laminated glass, the softening point of the adhesive layer 250 is higher than the glass transition point of the intermediate film 230. Accordingly, even when the surface of the adhesive layer 250 is not embossed, the adhesive layer 250 with excellent degassing can be realized so that degassing can be completed before the edge sealing is generated when the laminated glass is manufactured.

### First Modified Example of First Embodiment

A first modified example of the first embodiment explains an example in which an adhesive layer is also provided between a film and an intermediate film. Note that, in the first modified example of the first embodiment, the description of the same configuration portion as the embodiment described previously may be omitted.

FIG. 5 is a partial cross-sectional view of a windshield 20A having the same shape as FIG. 1A, and the view is that of a section taken in the x-z direction and viewed from y direction.

The windshield 20A illustrated in FIG. 5 differs from the windshield 20 (see FIG. 3) in that an adhesive layer 260 is provided between the film 240 and the intermediate film 230. As illustrated in FIG. 5, the windshield 20A is a laminated glass having the intermediate film 230, the film 240, and the adhesive layers 250 and 260 between the glass plate 210, which is the glass plate at a vehicle-interior-side, and the glass plate 220, which is the glass plate at a vehicle-exterior-side.

The film 240 and the adhesive layers 250 and 260 are disposed between the glass plate 210 and the intermediate film 230 in the HUD display area R₁ of the windshield 20A. The vehicle-interior-side surface of the film 240 is adhered to the vehicle-exterior-side surface of the glass plate 210 by the adhesive layer 250. The vehicle-exterior-side surface of the film 240 is adhered to the vehicle-interior-side surface of the intermediate film 230 by the adhesive layer 260.

The film 240 and the intermediate film 230 may be difficult to adhere directly, in which case it is preferable to have the adhesive layer 260 adhered to the vehicle-exterior-side surface of the film 240 instead of the vehicle-interior-side surface of the intermediate film 230.

The material of the adhesive layer 260 may be suitably selected from the materials exemplified as the material of the adhesive layer 250 in the first embodiment.

In this manner, the adhesive layer 260 may be provided to adhere the film 240 to the intermediate film 230. In this case also, the adhesive layers 250 and 260 with excellent degassing can be realized as in the first embodiment by increasing the softening point of the adhesive layers 250 and 260 higher than the glass transition point of the intermediate film 230.

### Second Embodiment

The second embodiment explains an example in which an adhesive layer and film are provided between a glass plate of vehicle-exterior-side and the intermediate film. In the second embodiment, the description of the same configuration portion as the embodiment described previously may be omitted.

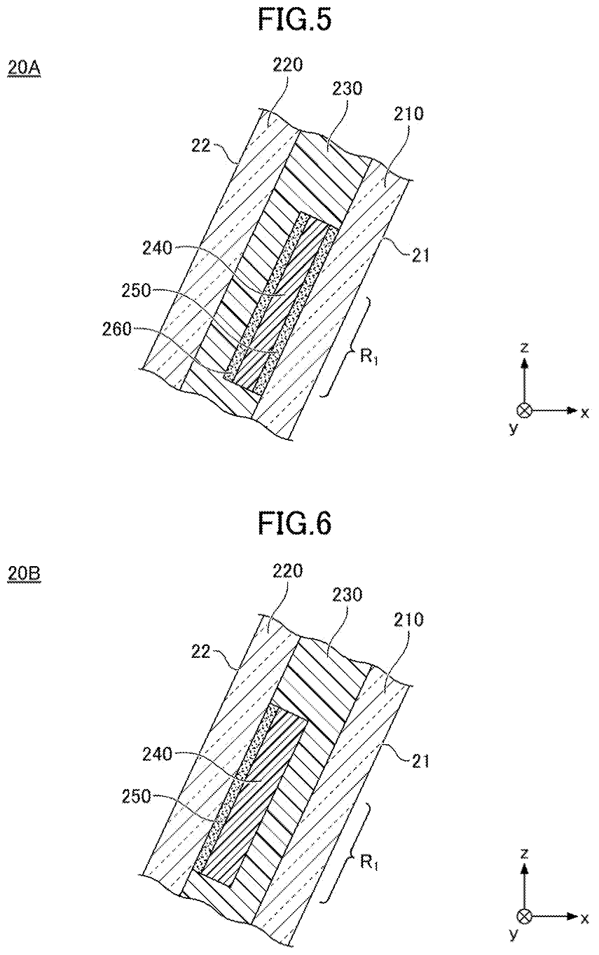

FIG. 6 is a partial cross-sectional view of a windshield 20B having a same shape as FIG. 1A, and the view is that of a section taken in the x-z direction and viewed from y direction. As illustrated in FIG. 6, the windshield 20B is a laminated glass having the intermediate film 230, the film 240, and the adhesive layer 250 between the glass plate 210, which is the glass plate at a vehicle-interior-side, and the glass plate 220, which is the glass plate at a vehicle-exterior-side.

In the HUD display area R₁ of the windshield 20B, the film 240 and the adhesive layer 250 are disposed between the glass plate 220 and the intermediate film 230. The vehicle-interior-side surface of the film 240 is adhered to the vehicle-exterior-side surface of the glass plate 210 by the intermediate film 230. The vehicle-exterior-side surface of the film 240 is adhered to the vehicle-interior-side surface of the glass plate 220 by the adhesive layer 250.

In this manner, the film 240 may be disposed on the side of the glass plate 220 rather than the intermediate film 230. In this case also, the adhesive layers 250 with excellent degassing can be realized as in the first embodiment by increasing the softening point of the adhesive layer 250 higher than the glass transition point of the intermediate film 230.

### First Modified Example of Second Embodiment

A first modified example of the second embodiment explains an example in which an adhesive layer is also provided between a film and an intermediate film. Note that, in the first modified example of the second embodiment, the description of the same configuration portion as the embodiment described previously may be omitted.

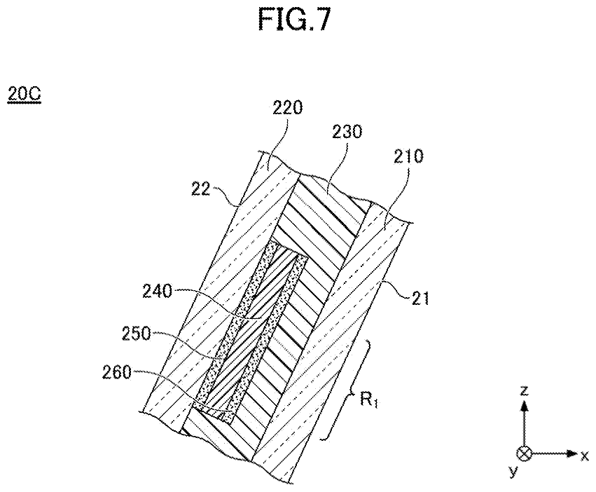

FIG. 7 is a partial cross-sectional view of a windshield 20C having a same shape as FIG. 1A, and the view is that of a section taken in the x-z direction and viewed from y direction.

The windshield 20C illustrated in FIG. 7 differs from the windshield 20B (see FIG. 6) in that the adhesive layer 260 is provided between the film 240 and the intermediate film 230. As illustrated in FIG. 7, the windshield 20C is a laminated glass having the intermediate film 230, the film 240, and the adhesive layers 250 and 260 between the glass plate 210, which is the glass plate at vehicle-interior-side, and the glass plate 220, which is the glass plate at vehicle-exterior-side.

In the HUD display area R₁ of the windshield 20C, the film 240 and the adhesive layers 250 and 260 are disposed between the glass plate 220 and the intermediate film 230. The vehicle-interior-side surface of the film 240 is adhered to the intermediate film 230 by the adhesive layer 260, and the intermediate film 230 is adhered to the vehicle-exterior-side surface of the glass plate 210.

The vehicle-exterior-side surface of the film 240 is adhered to the vehicle-interior-side surface of the glass plate 220 by the adhesive layer 250.

The film 240 and the intermediate film 230 may be difficult to adhere directly, in which case it is preferable to have the adhesive layer 260 adhered to the vehicle-interior-side surface of the film 240 instead of the vehicle-exterior-side surface of the intermediate film 230.

The material of the adhesive layer 260 may be suitably selected from the materials exemplified as the material of the adhesive layer 250 in the first embodiment. In addition, the softening point, thickness, relationship between the thickness and Young's modulus of the adhesive layer 260, the storage elasticity at a dynamic viscoelasticity measurement at a measurement frequency of 10 Hz, and the like are preferably equal to that of the adhesive layer 250.

Thus, the film 240 may be disposed on the side of the glass plate 220 instead of the intermediate film 230, and the adhesive layer 260 may be provided to adhere the film 240 and the intermediate film 230. In this case also, the adhesive layers 250 and 260 with excellent degassing can be realized as in the first embodiment by increasing the softening point of the adhesive layers 250 and 260 higher than the glass transition point of the intermediate film 230.

### EXAMPLES, COMPARATIVE EXAMPLES

Glass plates 210 and 220 were prepared, and laminated glass of Examples 1 to 9 and Comparative Example 1 were prepared by sandwiching an intermediate film 230, a film 240, and an adhesive layer 250.

The glass plates 210 and 220 were sized 300 mm×300 mm×2 mm in thickness. A resin (PVB manufactured by Sekisui Chemical Co., Ltd.) having a thickness of 0.76 mm and a glass transition point of 40° C. was used as the intermediate film 230. The film 240 used was a highly reflective film having a size of 150 mm×150 mm×100 μm in thickness coated with a titania coating on the PET. An epoxy-based adhesive was used as the adhesive layer 250. The highly reflective film was positioned in the center of the laminated glass. In the HUD display area, the vertical curvature of the laminated glass had a radius of 5,000 mm and the horizontal curvature of the laminated glass had a radius of 2,000 mm.

Examples 1 to 9 explain cross-sectional laminated glass illustrated in FIG. 3. In Example 1, the softening point of the adhesive layer 250 was at 50° C. and the thickness of the adhesive layer 250 was 70 μm. In Example 2, the softening point of the adhesive layer 250 was 70° C. and the thickness of the adhesive layer 250 was 70 μm. In Example 3, the softening point of the adhesive layer 250 was 90° C. and the thickness of the adhesive layer 250 was 70 μm. In Example 4, the softening point of the adhesive layer 250 was 70° C. and the thickness of the adhesive layer 250 was 60 μm. In Example 5, the softening point of the adhesive layer 250 was 70° C. and the thickness of the adhesive layer 250 was 20 μm. In Example 6, the softening point of the adhesive layer 250 was 70° C. and the thickness of the adhesive layer 250 was 5 μm. In Example 7, the softening point of the adhesive layer 250 was 70° C. and the thickness of the adhesive layer 250 was 3 μm. In Example 8, the softening point of the adhesive layer 250 was 70° C. and the thickness of the adhesive layer 250 was 2 μm. In Example 9, the softening point of the adhesive layer 250 was 70° C. and the thickness of the adhesive layer 250 was 1 μm.

Comparative example 1 is a cross-sectional-shaped laminated glass illustrated in FIG. 3. The softening point of the adhesive layer 250 was 40° C. and the thickness of the adhesive layer 250 was 70 μm.

First, in Examples 1 to 9 and Comparative Examples 1, a laminated body including the glass plates 210 and 220, the intermediate film 230, the film 240, and the adhesive layer 250 was placed in a rubber bag, the rubber bag was connected to the exhaust system. The laminated body was compressed in the rubber bag by performing vacuum suction (degassing) at the maximum temperature of 110° C. so that the degree of pressure reduction inside the rubber bag was −100 kPa. Then, the degassing state of the laminated body was evaluated after the degassing step (after the first compression bonding step). The criteria for the degassed state was evaluated by whether or not significant residual bubble was observed after the degassing step. The criteria for the degassing state were “A” when no significant residual bubble was found after the degassing step, and “B” when significant residual bubble was found after the degassing step.

Second, Examples 1 to 9 and Comparative Example 1 were evaluated for distortion of the HUD image reflected by an optical system including a concave mirror having a FOV of 4 deg×1 deg. Specifically, when a horizontal line with a width of 0.034 deg (=2 min) was projected 4 m ahead of the laminated glass, the “vertical distortion of the line” was evaluated. Then, the “vertical distortion of the line” of 0.009 deg or less was denoted by “A”, larger than 0.009 deg and smaller than 0.017 deg was denoted by “B”, and larger than 0.017 deg was denoted by “C”.

Third, Examples 1 to 9 and Comparative Example 1 were evaluated for distortion of the HUD image reflected by an optical system including a concave mirror having a FOV of 5 deg×1.5 deg. Specifically, when a horizontal line with a width of 0.034 deg (=2 min) was projected 4 m ahead of the laminated glass, the “vertical distortion of the line” was evaluated. Then, the “vertical distortion of the line” of 0.009 deg or less was denoted by “A”, larger than 0.009 deg and smaller than 0.017 deg was denoted by “B”, and larger than 0.017 deg was denoted by “C”.

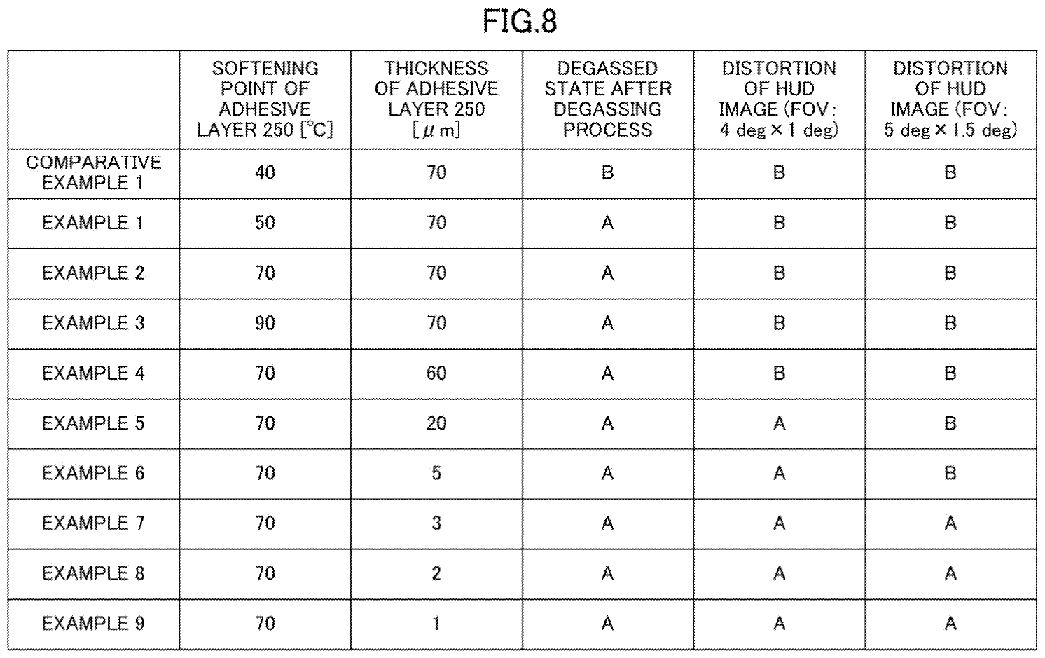

The first to third evaluation results of Examples 1 to 9 and Comparative Example 1 are summarized in FIG. 8. As illustrated in FIG. 8, Comparative Example 1 in which the softening point of the adhesive layer 250 is 40° C., which is equal to the glass transition point of the intermediate film 230, found significant residual bubbles after the degassing step. It is believed that this is because the adhesion of the adhesive layer 250 to the glass plate 210 progressed until the degassing time t₂ when the intermediate film 230 illustrated in FIG. 4 is completely adhered to the glass plates 210 and 220, and the degassing time of the adhesive layer 250 was not sufficiently secured.

On the other hand, in Examples 1 to 9, no significant residual bubble was found after the degassing step. This is because the softening point of the adhesive layer 250 is higher than the glass transition point of the intermediate film 230, the adhesion of the adhesive layer 250 to the glass plate 210 does not progress sufficiently until the degassing time t₂ when the intermediate film 230 completely adheres to the glass plates 210 and 220 illustrated in FIG. 4. Therefore, it is considered that this is because the degassing time t₂ of the adhesive layer 250 was sufficiently secured.

For the distortion of the HUD image reflected by the optical system including the concave mirror having the FOV of 4 deg×1 deg, it was confirmed that the “vertical distortion of the line” did not exceed 0.017 deg in both Examples 1 to 9 and Comparative Examples 1. It is considered that since the thickness of the adhesive layer 250 was 70 μm or less, the vehicle-interior-side surface and exterior-side surface of the film 240 followed the smooth surface of vehicle-exterior-side surface of the glass plate 210. Accordingly, the smoothness of the vehicle-interior-side surface and vehicle-exterior-side surface of the film 240 was maintained, thereby reducing the distortion of the HUD image.

In particular, in Examples 5 to 9, the “vertical distortion of the line” was 0.009 deg or less, and excellent results were obtained. It is considered that since the thickness of the adhesive layer 250 was 20 μm or less, the vehicle-interior-side surface and exterior-side surface of the film 240 could better conform with the smooth surface of vehicle-exterior-side surface of the glass plate 210. Accordingly, the smoothness of vehicle-interior-side surface and vehicle-exterior-side surface of the film 240 was improved, thereby reducing the distortion of the HUD image.

For the distortion of the HUD image reflected by the optical system including the concave mirror having the FOV of 5 deg×1.5 deg, it was confirmed that the “vertical distortion of the line” did not exceed 0.017 deg in both Examples 1 to 9 and Comparative Example 1. It is considered that since the thickness of the adhesive layer 250 was 70 μm or less, the vehicle-interior-side surface and exterior-side surface of the film 240 conformed with the smooth surface of vehicle-exterior-side surface of the glass plate 210. Accordingly, the smoothness of vehicle-interior-side surface and exterior-side surface of the film 240 was maintained, thereby reducing the distortion of the HUD image.

In particular, in Examples 7 to 9, the “vertical distortion of the line” was 0.009 deg or less, and excellent results were obtained. It is considered that since the thickness of the adhesive layer 250 was 3 μm or less, the vehicle-interior-side surface and exterior-side surface of the film 240 could better conform with the smooth surface of vehicle-exterior-side surface of the glass plate 210. Accordingly, the smoothness of vehicle-interior-side surface and exterior-side surface of the film 240 was improved, thereby reducing the distortion of the HUD image.

When the FOV becomes large, the distortion of the HUD image caused by the waviness of the film 240 becomes significant. However, when the thickness of the adhesive layer 250 was 3 μm or less, it was confirmed that the distortion of the HUD image can be sufficiently reduced even when the FOV was 5 deg×1.5 deg.

As described above, when the softening point of the adhesive layer 250 is higher than the glass transition point of the intermediate film 230, the degassing time t₂ of the adhesive layer 250 illustrated in FIG. 4 can be sufficiently secured, and a generation of significant residual bubble can be prevented after the degassing step.

In addition, when the thickness of the adhesive layer 250 adhering to the glass plate 210 and the film 240 is adjusted to 70 μm or less, the distortion of the HUD image can be reduced.

Although an example embodiment has been described in detail above, various modifications and substitutions can be made to the above-described embodiment without departing from the scope of the claims.

### DESCRIPTION OF THE REFERENCE NUMERALS

20, 20A, 20B, and 20C windshields
21 Inner surface
22 Outer surface
29 Black ceramic layer
210, 220 Glass plates
230 Intermediate film
240 Film
250, 260 Adhesive layers
R₁ HUD display area
R₂ HUD non-display area

1. A laminated glass having an intermediate film between a glass plate of a vehicle-exterior-side and a glass plate of a vehicle-interior-side, the laminated glass comprising:
a display area that reflects a projected image from a vehicle cabin and displays information; and
a film adhered to one of the glass plates by an adhesive layer is disposed between one of either of the glass plates of the vehicle-exterior-side and the vehicle-interior-side and the intermediate film in at least in a portion of the display area,
wherein the thickness of the adhesive layer is 0.2 μm or more and 70 μm or less, and
a softening point of the adhesive layer is higher than a glass transition point of the intermediate film.

2. The laminated glass according to claim 1, wherein the softening point of the adhesive layer is 50° C. or higher.

3. The laminated glass according to claim 1, wherein a difference between the softening point of the adhesive layer and the glass transition point of the intermediate film is 10° C. or more.

4. The laminated glass according to claim 1, wherein the glass transition point of the intermediate film is 40° C. or lower.

5. The laminated glass according to claim 1, wherein the thickness of the adhesive layer is 0.2 μm or more and 30 μm or less.

6. The laminated glass according to claim 1, wherein the thickness of the adhesive layer is 0.2 μm or more and 5 μm or less.

7. The laminated glass according to claim 1, wherein the thickness of the adhesive layer is 0.2 μm or more and 3 μm or less.

8. The laminated glass according to claim 1, wherein the laminated glass in the portion in which the film is disposed has a visible light reflectance of 9% or more or a diffuse reflectance of 9% or more.

9. The laminated glass according to claim 1,
wherein the film is a P-polarized reflective film, and
a reflectance of a P-polarization at a Brewster angle is 5% or more when the film is enclosed in the laminated glass.

10. The laminated glass according to claim 1, wherein the thickness of the film is 25 μm or more and 200 μm or less.

11. The laminated glass according to claim 1,
wherein a curvature in the display area of the laminated glass in a horizontal direction in a vehicle width direction has a radius in the rage of 1,000 mm to 10,000 mm and a curvature in the display area of the laminated glass in a vertical direction, in which the vertical direction is along the laminated glass, perpendicular to the horizontal direction has a radius in the range of 4,000 mm to 20,000 mm, when the laminated glass is mounted to the vehicle.

12. The laminated glass according to claim 1, wherein a field of view of the projected image is 4 deg×1 deg or more.
